(19) United States
(12) Patent Application Publication
(10) Pub. No.: US 2009/0252870 A1
(43) Pub. Date: Oct. 8, 2009

(54) APPARATUS AND METHOD FOR MOISTENING ENVELOPE FLAPS

(75) Inventor: Christiaan Antoon MUNNEKE, Drachten (NL)

Correspondence Address: SUGHRUE MION, PLLC, 2100 PENNSYLVANIA AVENUE, N.W., SUITE 800, WASHINGTON, DC, 20037, US

(73) Assignee: Neopost Technologies, Bagneux (FR)

(21) Appl. No.: 12/417,219

(22) Filed: Apr. 2, 2009

(30) Foreign Application Priority Data
Apr. 4, 2008 (EP) 08154090.8

(51) Int. Cl. B05D 5/10; B05C 11/10

(52) U.S. Cl. 427/207.1; 118/712; 118/688

(57) ABSTRACT

An apparatus for moistening flaps of envelopes has a liquid dispenser for dispensing liquid to the envelope flap of each envelope to be moistened. A liquid sensor is provided for sensing liquid carried by the dispenser and generating a humidity signal indicating an amount of the liquid held by the dispenser. A method for moistening flaps of envelopes is also described.

### FIELD AND BACKGROUND OF THE INVENTION

The invention relates to an apparatus and a method for moistening a flap of an envelope. In mail preparation machines such as inserters, postal items are mechanically inserted into envelopes. To seal the envelopes, flaps of the envelopes are each moistened and then closed so that the envelope is sealed.

From U.S. Pat. No. 4,930,441 an apparatus for moistening envelopes is known, which has a nozzle for spraying liquid onto the flap of each envelope to be sealed and a sensor positioned to detect liquid emitted from the nozzle. Prior to applying liquid to the flap of an envelope, the nozzle is controlled to briefly spray a jet of liquid. If the nozzle functions correctly the jet is detected by the sensor and its detection is signalled to a microcomputer as an indication that the nozzle is functioning properly. If the jet of liquid is not detected, such a signal will not be received. Thus, absence of such a signal indicates that the liquid supply needs to be adequately filled.

A drawback is that every time the nozzle is tested, liquid is spilled. Another drawback is that the sensor only detects if a liquid-jet has been generated or not prior to moistening the envelope flap. Whether an adequate liquid jet is sprayed to the flap of the envelope, sufficiently moistening the flap for successfully sealing the envelope is not detected.

From U.S. Pat. No. 3,350,351 an apparatus for moistening envelopes is known which is equipped with a liquid dispenser composed of a wick of felt material directly connected to a water reservoir and brushes that are movable between an extended position in contact with the felt or with an envelope and a retracted position spaced from the felt. The brushes are wetted by bringing the brushes in the extended position in contact with the felt and subsequently retracted. Each time an envelope passes, the brushes are extended and wet gummed areas of the flap at top trailing side of the flap. A drawback of this apparatus is that if the apparatus is started immediately after the water reservoir has been filled, it occurs often that, initially, the envelopes that are closed are not properly sealed and require manual rework to seal the envelopes adequately. This problem can be avoided by waiting before starting the machine after the filling of the water reservoir. However, this requires patience and discipline and is time consuming. Therefore, operators are tempted not to wait sufficiently long before starting the apparatus after the filling of the water reservoir.

### SUMMARY OF THE INVENTION

It is an object of the present invention to allow automatic checking whether the dispenser of an envelope moistening apparatus is in a condition adequate for moistening of an envelope flap without spilling moistening liquid and during operation without requiring special movements of the dispenser, so that it can easily be ascertained whether the apparatus is ready to reliably seal envelopes.

According to the invention, this object is achieved by providing an apparatus for moistening flaps of envelopes, having:

an envelope support for supporting an envelope having an envelope body and a flap to be moistened and pivotably connected to the envelope body along a fold, with the envelope flap in an open position;

a liquid reservoir;

a liquid dispenser for dispensing some of the liquid to the envelope flap;

a conduit via which the dispenser communicates with the liquid reservoir; and

a liquid sensor for sensing liquid carried by the dispenser and generating a humidity signal indicating a sensed amount of the liquid carried by the dispenser.

The invention can also be embodied in a method for moistening flaps of envelopes, comprising, for each envelope flap to be moistened:

supporting an envelope having an envelope body and a flap to be moistened and pivotably connected to the envelope body along a fold, with the envelope flap in an open moistening position;

in response to the presence of the envelope flap in the moistening position, dispensing liquid from a liquid dispenser to the envelope flap;

replenishing dispensed liquid with liquid from a liquid reservoir via a conduit via which the liquid is supplied from the liquid reservoir to the dispenser;

sensing liquid carried by the dispenser; and

in response to an amount of liquid sensed, generating a humidity signal indicating a sensed amount of the liquid carried by the dispenser.

By sensing liquid carried by the dispenser and generating a humidity signal indicating whether at least a predetermined amount of the liquid is held by the dispenser, it is possible to monitor whether the humidity and thus the amount of liquid of a liquid dispenser is sufficient for moistening the flap and sealing the envelope successfully, without spilling liquid and to do so during operation, for instance during moistening or between application of liquid to two successive envelope flaps.

Particular elaborations and embodiments of the invention are set forth in the dependent claims.

Further features, effects and details of the invention appear from the detailed description and the drawings.

### BRIEF DESCRIPTION OF THE DRAWINGS

FIG. 1 is a schematic perspective representation of an example of an envelope closing apparatus;

FIG. 2 is a schematic perspective representation of the envelope closing apparatus of FIG. 1 in another stage of operation;

FIG. 3 is a circuit diagram of an example of an apparatus according to the invention,

FIG. 4 is a schematic side view of another example of an apparatus according to the invention,

FIG. 5 is a schematic front view of the apparatus of FIG. 4;

FIG. 6 is a schematic side view of another example of an apparatus according to the invention;

FIG. 7 is a schematic representation of an envelope flap moistener implemented as part of an inserting apparatus;

FIG. 8 is a schematic representation of a liquid dispenser with a liquid sensor based on capacitance.

### DETAILED DESCRIPTION

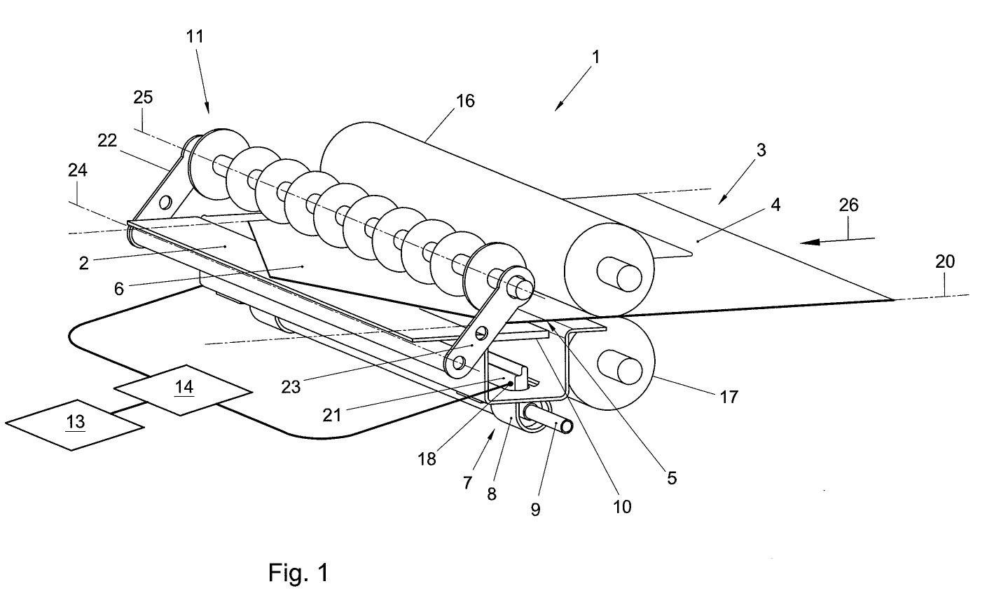

An envelope closing mechanism as shown in FIG. 1 is known from European Patent Application 1 674 290. It is equipped with a support 2 for supporting an envelope 3 in a transport path 20. The envelopes to be closed are of the type having an envelope body 4 for accommodating a content, and a flap 6 connected via a fold 5 to one of two walls of the envelope body 4. The fold 5 constitutes a hinge about which the flap 6, upon closing, hinges relative to the envelope body 4. The envelope 3 represented in FIG. 1 lies flat in the transport path 20 while a side of the flap 6, provided locally with glue, is in open position facing downwards.

A pair of pressing rollers 16, 17, of which rollers one is drivable, also form a transporting structure for moving the envelope 3 along the transport path 20.

At a first side of the transport path 20 a moistener 7 is situated for moistening the flap 6. The moistener 7 is equipped with a liquid dispenser, in this example a moistening cushion 21, a liquid reservoir 8 and a liquid supply control unit, in this case a liquid pump 9 for pumping the liquid through a conduit in a dosed manner to the moistening cushion 21, and is located at some distance from the transport path 20.

With the envelope closing mechanism 1 in the position of rest, the moistener 7 is shielded from the envelope 3 by a hinged panel 10. The panel 10 is urged to its shielding position through spring force.

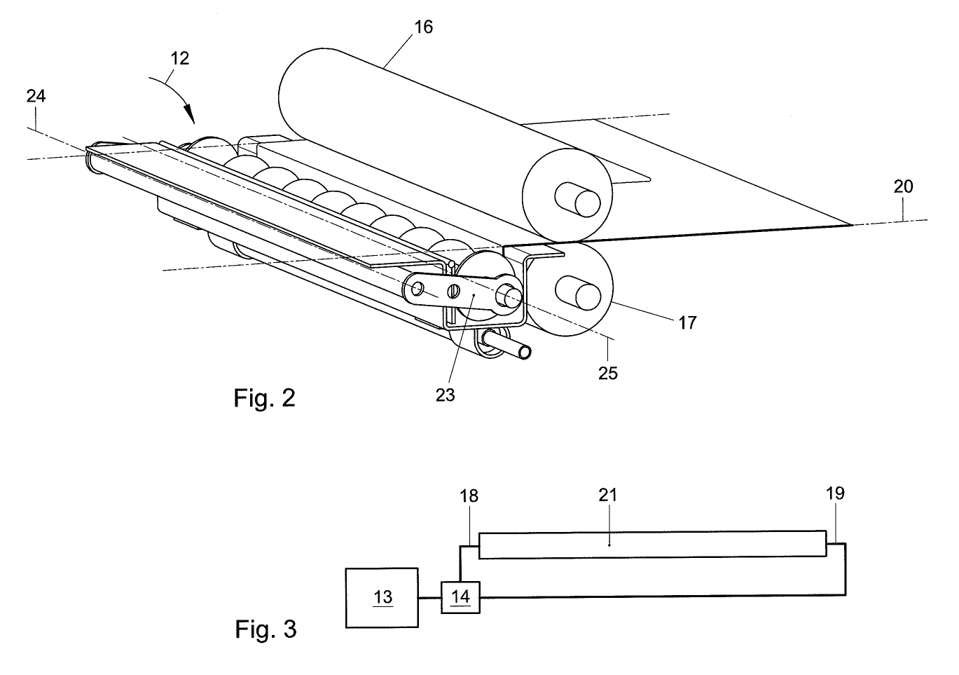

In a position of rest (see FIG. 1), a deflector 11 movable between two positions, is situated on a side of the transport path 20 opposite the moistener 7, according to this example, the top side. Via two arms 22, 23, the deflector 11 is pivotally suspended about an axis 24. In the deflecting position (see FIG. 2), the deflector 11 is located at the same side of the transport path as the moistener 7. The deflector 11 has a row of discs, axially spaced, coaxially and rotatably suspended about a rotation axis 25 (see FIGS. 1 and 2). The rotation axis 25 of the discs is directed parallel to the plane of the transport path 20 defined by the guide 2, and moves with the deflector 11 upon displacement thereof between the position of rest and the deflecting position.

In operation, the envelope 3 is brought to a position in which the flap 6 of the envelope 3 is located approximately opposite the deflector 11. By then moving the deflector 11 in the direction indicated by arrow 12 in FIG. 2 from the position of rest to the deflecting position, the deflector 11 urges both the panel 10 to its releasing position and the flap 6 from the transport path against the moistener 7 which, initially, was shielded by the panel 10. The contact between the flap 6 and the moistener 7 is achieved by bending the flap 6 towards the moistener 7 in such a manner that a gummed portion of the flap 6 projecting from the deflector is pushed against the moistener 7. Then the envelope is moved with the fold 5 leading, along the transport path 20, whereby the leading fold 5 and the portions of the envelope 3 contiguous thereto, follow the transport path 20, along the deflector 11 which is in deflecting position. This causes the flap 6 to be pulled from between the moistener 7 and the deflector 11, causes the gummed portions of the flap trailing the initially moistened portion to be moistened, and causes the flap 6 to be closed. After closing the flap 6 of the envelope 3, the envelope 3 is led in opposite direction through the nip between the pressing rollers 16, 17, for pressing-on the folded-up flap 6 and causing the moistened glue to adhere effectively to the envelope body.

As is best seen in FIGS. 1 and 3, the apparatus is equipped with a liquid sensor composed of measuring circuitry 14 and two mutually spaced electrodes 18, 19 connected thereto and in contact with the moistening cushion 21 in mutually spaced positions. The electric resistance between the electrodes 18, 19 is dependent on the humidity of (i.e. the amount of liquid absorbed in) the moistening cushion 21. When the moistening cushion is in a relatively dry condition, the electrodes are electrically insulated and thus the resistance between the electrodes 18, 19 is relatively high. Conversely, when the moistening cushion 21 is in a relatively wet condition, the resistance between the electrodes 18, 19 is relatively low. Thus a signal from the measuring circuitry 14 that is a measure for the resistance between the electrodes 18, 19 constitutes an indication of the humidity of the moistening cushion and thus whether at least a predetermined amount of liquid is held by the moistening cushion 21. This signal also constitutes an indication of suitability of the condition of the moistening cushion 21 for adequately moistening the flap of an envelope.

A signal processing circuit 13 is connected to the measuring circuitry 14 and arranged for selectively generating a signal in response to a humidity signal from the measuring circuitry 14. The signal may for instance be generated selectively only if the signal from the humidity sensor indicates that the humidity is above a predetermined level.

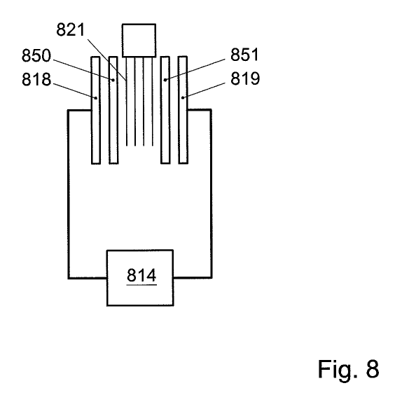

Instead of or in addition to a signal indicating the resistance between the electrodes, as is illustrated by FIG. 8, the humidity of the liquid dispenser 821 may also be obtained by a signal indicating the capacity of a capacitor constituted by mutually spaced capacitor plates 818, 819 and insulators 850, 851, and at least a portion of the liquid dispenser 821 between the capacitor plates 818, 819. The liquid dispenser (in the form of a brush) 821 is shown in a retracted position where its humidity can be measured by a measuring circuitry 814 connected to the capacitor plates 818, 819 and can be extended from between the capacitor plates 818, 819 to a liquid application position for contacting a flap of an envelope (not shown). An advantage of measuring the capacity of a capacitor including the liquid dispenser between the capacitor plates over the use of electrodes is that the measurement is not disturbed by variations in the electric conductivity in the contact area of the electrodes.

The humidity of the moistening cushion determines the impedance, whether resistive or capacitive, detected by the sensor, which generates a humidity signal that indicates the amount of liquid held by the moistening cushion 21. In response to a change in the impedance due to a change in humidity, the humidity signal generated by the sensor will change accordingly. The signal processing circuitry 13 selectively generates signals in accordance with the humidity indicating signals from the measuring circuitry 14. These signals generated by the signal processing circuitry 13 may be used to control the liquid pump 9 for controlling the liquid supply from the liquid reservoir 8 to the moistening cushion 21, such that sufficient but not too much liquid is fed to the moistening cushion 21.

The envelope flap moistening apparatus may be implemented as a separate apparatus or, as is illustrated by FIG. 7, as part of an inserter for inserting documents into envelopes. In such an inserter 733, a control unit 734 controls operation of feeding stations 735, 736, folding station 737 and moistening station 701 of the inserter 733. The signal processing circuitry 713 is connected to the control unit 734 which is programmed to defer operation of the inserter 733 including the envelope flap moistening apparatus 701 if a signal from the measuring circuitry 714 indicates absence of at least a predetermined amount of the liquid at the liquid dispenser 721. The control unit may also be connected to a signaling device for generating a humanly perceptible warning signal in response to a signal from the signal processing circuitry 713 indicating that an insufficient amount of the liquid is present at the liquid dispenser for reliably sealing envelopes.

Furthermore, the control unit 734 may also be arranged to automatically start operation of the inserter 733 including the envelope flap moistening apparatus 701 in response to a signal from the measuring circuitry 714 of the liquid sensor indicating presence of at least a predetermined amount of the liquid at the liquid dispenser 721. In this way an operator of the inserter 733 does not need to check and wait until the liquid dispenser 721 is adequately moistened, but operation of the inserter 733 is automatically deferred until the liquid sensor signals that the dispenser 721 has reached a degree of humidity that is sufficient to ensure reliable sealing of envelopes. Measurements signals from the measuring circuitry 713 may be processed continuously or repeatedly, at least until a signal indicating sufficient humidity has been generated and processed.

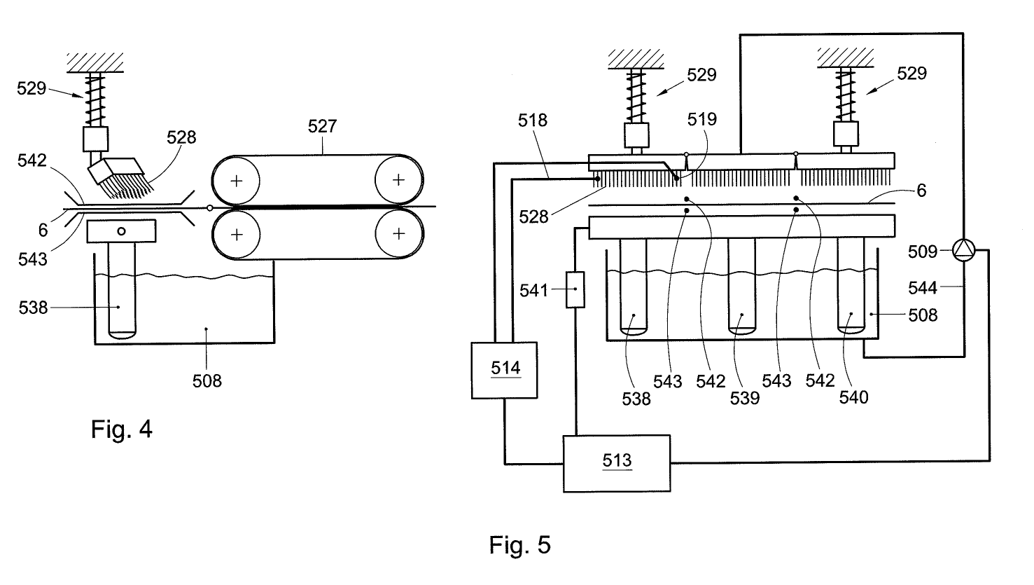

In FIGS. 4 and 5, an example of an apparatus according to the invention is shown which is equipped with a liquid level meter having probes 538, 539, 540 for measuring the amount of liquid in a liquid reservoir 508. The probes 538, 539, 540 are connected to a liquid level measuring circuitry 541, which generates a measuring signal indicative of the volume of liquid in the liquid reservoir 508. The signal processing circuitry 513 generates a warning signal indicating that the liquid reservoir 508 needs to be filled in response to a measurement signal from the measuring circuitry 514 indicative of a liquid level in the liquid reservoir 508 below a predetermined level. For moistening the envelopes, a liquid dispenser in the form of a brush 528 is mounted downstream of a transport conveyor 527 to lift units 529 for displacing the brush 528 between an extended position for moistening an envelope flap 6 in a transport path defined by guides 542, 543 and a retracted position spaced from the transport path.

In operation, envelopes are fed by the transport belts 527 and the flap 6 of an envelope is moistened from above by the brush 528. For supplying liquid to the brush 528 a liquid, a conduit 544 extends from the liquid reservoir 508 to the brush 528 and the conduit extends through a pump 544 for pumping liquid from the liquid dispenser 508 to the brush 528. The brush 528 constitutes a structure bounding a plurality of voids, which allows to hold liquid due to capillary effects. The processing circuitry 513 receives humidity signals from the measuring circuit 514, to which a pair of electrodes 518, 519 is connected. The electrodes 518, 519 contact the hairs of the brush 528 in spaced apart positions for measuring the resistive impedance of the brush 528. The humidity signals from the sensor 514 are processed by the signal processing circuitry 513 into signals indicating whether the brush 528 is humid enough for reliably sealing envelopes. If the signal from the measuring circuitry 514 indicates that the brush 528 is not sufficiently humid, a signal from the processing circuitry 513 causes operation of the apparatus to stop or to be deferred without causing a humanly perceptible signal to be generated. A humanly perceptible signal indicating that the liquid reservoir 508 needs to be filled is generated only if the measurement signal received from the liquid level measuring circuitry 541 indicates that the liquid reservoir 508 is empty or almost empty. Even if such a signal is generated, the apparatus can continue to run until a signal from the processing circuitry 513 indicates that the brush 528 is not humid enough for reliably sealing envelopes. The signal processing circuitry 513 is also connected to the pump 509 to activate and deactivate the pump 509 in response to signals from the measuring circuitry 513 indicating that humidity of the brush 528 is outside a preferred operating range. The lowest humidity of this operating range is significantly higher than the humidity level at which operation of the apparatus is stopped or deferred.

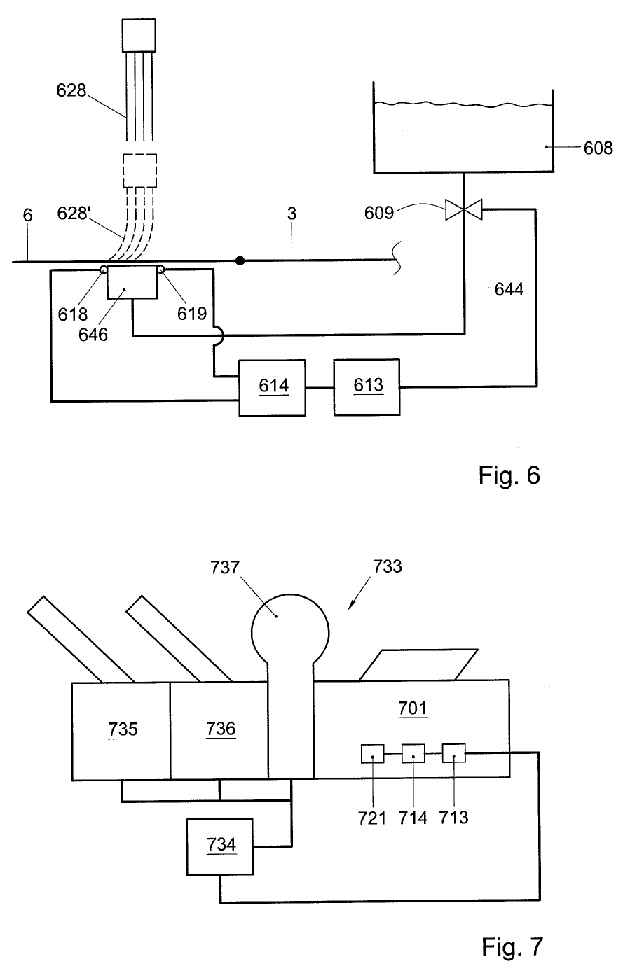

In FIG. 6 yet another example of an apparatus according to the invention is shown. In this apparatus, the liquid dispenser is provided in the form of a combination of a brush 628, which is vertically movable between a lifted position 628 drawn in full lines and a lowered position 628′ drawn in broken lines, and a wick 646. In the lowered position, the brush 628′ either contacts a flap 6 of an envelope 3 to be moistened for moistening that flap 6 or, if no envelope is present below the brush 628′, the wick 646 for moistening the brush 628 by picking up a volume of liquid from the wick 646, which is about equal to the volume of liquid applied to the last envelope flap 6 and to be applied to the next envelope flap. The wick 646 and the brush 628 thus constitute an arrangement for dispensing dosed amounts of liquid to the envelope flaps 6.

In the present example, the wick 646 is an element of porous material through which liquid can be passed and of which an outer surface can be wetted by feeding liquid to the wick 646. Depending on the amounts of liquid to be dispensed and the rate at which envelopes are to be moistened, it can be advantageous to provide the wick in the form of a sponge. By compressing the sponge just before or during contact with the brush or other liquid applicator, the transfer of liquid to the liquid applicator can be speeded up. Compression of the sponge can be achieved under influence of pressure exerted by the liquid applicator or using a separate pressing member.

To feed liquid to the wick 646, the wick 646 communicates with a liquid reservoir 608 via a liquid supply conduit 644 in which a control valve 609 is arranged. The liquid reservoir 608 is located above the wick 646, so that liquid can flow towards the wick 646 under influence of gravity. Electrodes 618, 619 contact the wick 646 in spaced apart positions near opposite ends of an outer surface of the wick 646 that faces the brush 628. The electrodes 618, 619 are connected to a measuring circuitry 614, which generates a measuring signal indicative of the volume of liquid in the wick 646. The measuring circuitry 614 is connected to a signal processing circuitry 613 for receiving humidity signals from the measuring circuit 614. The humidity signals from the sensor 614 are processed by the signal processing circuitry 613 into control signals to open the valve 609 for a brief predetermined period of time in response to a signal from the measuring circuitry 613 indicating that humidity of the wick 646 is too low.

While the invention has been illustrated and described in detail in the drawing and foregoing description, such illustration and description are to be considered illustrative or exemplary and not restrictive; the invention is not limited to the disclosed embodiments. For instance, the liquid dispenser may be provided in the form of a spraying head, the measuring circuitry may be integrated with the signal processing circuitry or the signal processing circuitry may be integrated in a control system of an inserter system. For instance if the liquid applicator includes a brush and a wick having a wetted surface from which the brush can pick up liquid, the wick can be also in direct contact with the water supply so that there is no need for a wick or a conduit from the water reservoir to the wick. Also, the liquid sensor can be arranged to measure the amount of liquid held by brush as an addition to or an alternative for measuring whether the wick holds sufficient liquid.

Other variations to the disclosed embodiments can be understood and effected by those skilled in the art in practicing the claimed invention, from a study of the drawings, the disclosure, and the appended claims.

1. An apparatus for moistening flaps of envelopes, comprising:
an envelope support for supporting an envelope having an envelope body and a flap to be moistened and pivotably connected to the envelope body along a fold, with the envelope flap in an open position;
a liquid reservoir;
a liquid dispenser for dispensing some of the liquid to the envelope flap;
a conduit via which the dispenser communicates with the liquid reservoir; and
a liquid sensor for sensing liquid carried by the dispenser and generating a humidity signal indicating a sensed amount of the liquid carried by the dispenser.

2. An apparatus according to claim 1, further comprising a signal processing circuit operatively connected to the liquid sensor and arranged for selectively generating a signal in response to a humidity signal received from the liquid sensor.

3. An apparatus according to claim 2, further comprising a liquid supply control for controlling liquid supply from the reservoir via the conduit to the dispenser; wherein the signal processing circuitry is operatively connected to the liquid supply control for controlling the liquid supply in accordance with humidity signals received from the liquid sensor.

4. An apparatus according to claim 1, wherein the liquid dispenser comprises a liquid applicator having a structure bounding a plurality of voids for temporarily storing liquid to be applied.

5. An apparatus according to claim 4, wherein the liquid applicator comprises a brush.

6. An apparatus according to claim 4, wherein the liquid applicator comprises a wick.

7. An apparatus according to claim 1, wherein the liquid sensor comprises mutually spaced electrodes mounted to the liquid dispenser and measuring circuitry for detecting electric resistance between the electrodes, and wherein the electrodes are electrically more insulated from each other when the dispenser is in dry condition than when the dispenser is in humid condition.

8. An apparatus according to claim 4, wherein the liquid sensor comprises mutually spaced capacitor plates and insulators leaving room for the liquid applicator between the capacitor plates insulated from the capacitor plates, such that, when the liquid applicator is located at least partially between the capacitor plates, the capacitor plates and at least a portion of the liquid dispenser constitutes a capacitor, and a detecting circuitry for detecting the capacity of said capacitor.

9. A mail preparation apparatus comprising an inserter for inserting documents into envelopes, an apparatus for moistening a flap of an envelope according to claim 2, and a control unit for controlling operation of the mail preparation apparatus, wherein the signal processing circuitry and the control unit are arranged for deferring operation of the inserter in response to the liquid sensor indicating absence of at least the predetermined amount of the liquid at the liquid dispenser.

10. A mail preparation apparatus according to claim 9, wherein the control unit is arranged for automatically starting operation of the inserter in response to a signal from the liquid sensor indicating presence of at least the predetermined amount of the liquid at the liquid dispenser.

11. A mail preparation apparatus according to claim 9, wherein the control unit is arranged for causing generation of a warning signal in response to a signal from the liquid sensor indicating absence of at least the predetermined amount of the liquid at the liquid dispenser for at least a predetermined period of time.

12. A method for moistening flaps of envelopes, comprising, for each envelope flap to be moistened:
supporting an envelope having an envelope body and a flap to be moistened and pivotably connected to the envelope body along a fold, with the envelope flap in an open moistening position;
in response to the presence of the envelope flap in the moistening position, dispensing liquid from a liquid dispenser to the envelope flap;
replenishing dispensed liquid with liquid from a liquid reservoir via a conduit via which the liquid is supplied from the liquid reservoir to the dispenser;
sensing liquid carried by the dispenser; and
in response to an amount of liquid sensed, generating a humidity signal indicating a sensed amount of the liquid carried by the dispenser.

13. A method according to claim 12, further comprising selectively generating a signal in response to the humidity signal received from the liquid sensor.

14. A method according to claim 12, further comprising controlling the liquid supply in accordance with humidity signals received from the liquid sensor.
